(19) United States
(12) Patent Application Publication
(10) Pub. No.: US 2025/0313213 A1
(43) Pub. Date: Oct. 9, 2025

(54) METHOD FOR APPROXIMATING A FRICTION VALUE

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/245,038

(22) Filed: Jun. 20, 2025

Related U.S. Application Data
(63) Continuation of application No. PCT/EP2023/083322, filed on Nov. 28, 2023.

(30) Foreign Application Priority Data
Dec. 20, 2022 (DE) 10 2022 134 152.6

(51) Int. Cl. B60W 40/068; B60W 30/02

(52) U.S. Cl. CPC B60W 40/068; B60W 30/02; B60W 2510/202; B60W 2510/205; B60W 2520/125; B60W 2540/18; B60W 2555/20; B60W 2710/207

(57) ABSTRACT

A method for approximating a friction value includes: determining a load characteristic; determining a setpoint variable of the vehicle; determining a manipulated variable expected value specifying a predicted value of a manipulated variable to be provided to set the setpoint variable, wherein the determination of the manipulated variable expected value is performed using the load characteristic; determining an actual variable corresponding to the setpoint variable; determining a manipulated variable actual value, which is provided at the steering system, in order to modulate the actual variable; determining a manipulated variable deviation between the manipulated variable expected value and the manipulated variable actual value; and/or determining a setpoint-actual deviation between the setpoint variable and the corresponding actual variable; approximating the friction value based on the determined load characteristic and based on the determined manipulated variable deviation and/or the determined setpoint-actual deviation. A driver assistance system is configured to carry out the method.

### CROSS-REFERENCE TO RELATED APPLICATIONS

This application is a continuation application of international patent application PCT/EP2023/083322, filed Nov. 28, 2023, designating the United States and claiming priority from German application 10 2022 134 152.6, filed Dec. 20, 2022, and the entire content of both applications is incorporated herein by reference.

### TECHNICAL FIELD

The disclosure relates to a method for approximating a friction value between wheels of a vehicle and a roadway. Furthermore, the disclosure relates to a driver assistance system, a vehicle, and a computer program product.

### BACKGROUND

The capacity of a vehicle to change its speed or direction substantially depends on the forces which the tires of the vehicle can transmit to a roadway. The most important influencing variable for the transmittable forces is the friction value between the road and the tires of the vehicle. This friction value is influenced by the set of tires of the vehicle and by properties of the roadway. In particular the roadway properties can vary significantly in the course of a journey.

A human driver assesses the roadway conditions visually through a windshield of the vehicle and/or acoustically by way of rolling noises of the wheels of the vehicle on the roadway. For this purpose, a human driver uses experience and knowledge about a current set of tires and a steering behavior of the vehicle and additionally takes into consideration current weather conditions. The current friction value is essential for safe vehicle control, since the driving style can be adjusted with the aid of this information in that the intended vehicle movement is compared to the actual vehicle movement. An experienced motor vehicle driver thus continuously assesses which longitudinal and lateral accelerations are possible without hazard for the vehicle. For correct assessment of the forces transmittable to the roadway for the control of the vehicle and therefore also the possible movement changes of the vehicle, long-time experience is indispensable. In particular unpracticed drivers can incorrectly assess the friction value between the wheels of the vehicle and the roadway, due to which there is a significant risk of accident. A reliable assessment of the friction value is also important for safe operation of the vehicle in autonomous vehicles.

Sensor-based approaches for automated assessment of roadway conditions are known. Thus, for example, optical sensors are available, which optically capture a roadway located in front of the vehicle and evaluate the optically captured image data to assess adhesion properties of the roadway surface. However, these sensors have multiple disadvantages. First, the results are strongly influenced on the properties of the sensor and are not usable in all driving situations under certain circumstances. Thus, for example, systems which use conventional cameras can only be used during the day due to poor light conditions. Furthermore, optical systems only take into consideration aspects of the roadway and neglect vehicle-specific aspects.

### SUMMARY

It is an object of the present disclosure to specify a method for approximating a friction value between wheels of a vehicle and a roadway, a driver assistance system, a vehicle, and/or a computer program product which is preferably sufficiently accurate, enables improved safety, and/or is reliably usable.

In a first aspect, the disclosure achieves the above-mentioned object via a method for approximating a friction value between wheels of a vehicle in a current vehicle configuration and a roadway, wherein the method includes the following steps: determining at least one load characteristic of the current vehicle configuration; determining a setpoint variable of the vehicle for a driving situation; determining a manipulated variable expected value, which specifies a predicted value of a manipulated variable to be provided to set the setpoint variable on a steering system; determining an actual variable corresponding to the setpoint variable in the driving situation; determining a manipulated variable actual value which is provided to the steering system in the driving situation in order to modulate an actual variable; determining a manipulated variable deviation between the manipulated variable expected value and the manipulated variable actual value, and/or determining a setpoint-actual deviation between the setpoint variable and the actual variable; and approximating the friction value based on the determined load characteristic and based on the determined manipulated variable deviation and/or the determined setpoint-actual deviation.

The disclosure is based on the finding that the manipulated variable to be provided to set a specific output variable or actual variable on a steering system corresponds to the friction value between the wheels of the vehicle and the roadway. A force to be provided to rotate the wheels or a torque to be provided to rotate the wheels is all the greater in broad operating ranges the greater the friction value is between the roadway and the steered wheels. The disclosure makes use of this finding in order to approximate the current friction value based on the actual variable and the corresponding manipulated variable. Furthermore, the disclosure is based on the finding that not only a torque applied to a steered wheel, but also a load of the steered wheel is of decisive importance. This load of the steered wheel is taken into consideration by the load characteristic. The method allows a very simple, cost-effective, and/or rapid approximation of the friction value, since the approximation is based on deviations between expected values and variables actually occurring during the driving situation. The method can advantageously be performed using vehicle sensors (or their signals) which are already present in modern vehicles.

The friction value determines the maximum forces transmittable between vehicle and roadway. The driving situation is preferably a steering situation of the vehicle, thus a situation in which the position of the wheels of the vehicle, the alignment of the vehicle, and/or the yaw rate of the vehicle changes. For example, the driving situation is a cornering operation of a vehicle or a segment of a cornering operation. The driving situation is not a discrete point in time, but rather a period of time. The driving situation includes at least one period of time which is required to induce a change of the actual variable by specifying a manipulated variable and/or to achieve an effect on the vehicle as a result of the change of the actual variable. The driving situation can preferably also include a standstill of the vehicle. The driving situation can include, for example, test steering of a stationary vehicle.

The manipulated variable can be a variable modulated directly at the tires by the steering system. However, the manipulated variable is preferably a physical variable which is provided to the steering system in order to modulate an actual variable corresponding to the manipulated variable.

The manipulated variable expected value is the value of the manipulated variable which has to be provided to the steering system according to a prediction in order to modulate the setpoint variable intended for a driving situation. The manipulated variable actual value, in contrast, is the value of the manipulated variable actually provided to the steering system in the driving situation. It is to be understood that by providing the manipulated variable actual value or a manipulated variable in the amount of the manipulated variable actual value in the driving situation, an actual variable which corresponds to the setpoint variable does not necessarily also have to be modulated. In the driving situation (actual situation), the actual variable can thus be identical to or different from the setpoint variable. Moreover, in the actual situation, the actual manipulated variable can be identical to or different from the setpoint manipulated variable. For example, both a setpoint-actual deviation and a manipulated variable deviation can occur in the driving situation. It is to be understood that a determination of a setpoint-actual deviation can also be performed for the case of an actual variable corresponding to the setpoint variable and/or a determination of a manipulated variable deviation can also be performed for the case of an actual manipulated variable corresponding to the setpoint manipulated variable. In this case, a value of zero is determined for the setpoint-actual deviation or the manipulated variable deviation.

The approximation of the friction value based on the determined load characteristic and based on the determined manipulated variable deviation is preferably only performed if the manipulated variable actual value lies outside a manipulated variable tolerance around the manipulated variable expected value and/or is only performed based on the determined setpoint-actual deviation if the actual variable lies outside an actual variable tolerance around the setpoint variable.

In a first embodiment of the method, the setpoint variable is or includes a setpoint steering angle speed of the vehicle and the actual variable is or includes an actual steering angle speed. The steering angle speed, thus the speed of change of the steering angle, which can be specified, for example, in °/s, corresponds particularly directly to the friction value for a constant steering torque applied to set the steering angle and is therefore particularly suitable as a setpoint variable or actual variable.

The manipulated variable preferably is or includes a steering torque provided to the steering system, in particular to a steering column of the steering system. This steering torque can be transmitted directly to the wheels or also can be amplified by a power steering system. The steering torque preferably includes the sum of all steering torques provided for steering the steered wheels. However, the manipulated variable can also be a current manipulated variable provided to a servomotor of the steering system. The steering system is preferably an active steering system, which provides the actual steering torque at least partially based on electrical signals.

The vehicle is normally controlled in the driving situation so that the actual steering angle speed essentially corresponds to the setpoint steering angle speed, since a deviation of the actual steering angle speed from the setpoint steering angle speed results in a delayed or excessively fast steering reaction of the vehicle. This can in turn result in a significant deviation of the vehicle from a planned path. Depending on the level or value of the friction value, the actual manipulated variable which is required to reach an actual steering angle speed corresponding to the setpoint steering angle speed can vary strongly. With an icy roadway, for example, a significantly lower steering torque has to be applied in order to turn the steered wheels than in the case of wheels which have contact with a rough roadway. Therefore, the manipulated variable deviation can normally be determined to approximate the friction value. However, it can occur that an actual steering angle speed corresponding to the setpoint steering angle speed cannot be modulated. This is the case, for example, if a maximum permitted steering torque would have to be exceeded for this purpose. For the case that such a setpoint-actual deviation exists, it can also be used to approximate the friction value. Of course, the friction value can also be approximated based on the determined manipulated variable deviation and the determined setpoint-actual deviation.

In a refinement, the method furthermore includes determining a lateral acceleration of the vehicle in the driving situation, wherein the approximation of the friction value is preferably additionally performed based on the lateral acceleration. When a vehicle travels through a curve, a lateral acceleration always acts on the vehicle. This lateral acceleration causes rocking of the vehicle around a vehicle longitudinal axis. Wheels on the outside of the curve are loaded and wheels on the inside of the curve are relieved in this case. This load change can have an effect on the actual variable, in particular if the steering angle speed is viewed as the actual variable. As a result of a positive scrub radius, which is typically present in trucks, a greater deceleration torque can thus result on a wheel on the outside of the curve than on a wheel on the inside of the curve. This additional torque dependent on the lateral acceleration influences the steering angle speed achievable by specifying a specific steering torque. The preferred approximation of the friction value additionally based on the lateral acceleration thus permits a more accurate approximation.

The approximation of the friction value is preferably only performed if the lateral acceleration is below a lateral acceleration limiting value. The lateral acceleration limiting value is preferably less than or equal to 2 m/s². An influence of the lateral acceleration on the approximation of the friction value can be limited by the lateral acceleration limiting value. The method can be performed with less effort and/or more exactly.

According to an embodiment of the method, the load characteristic is or includes a current axle load of a steering axle of the vehicle steered by the steering system. The current axle load is the load which is present on the steered steering axle in the driving situation. In this case, the current axle load is the axle load present at the moment or in the period of time of determining the actual variable. However, it is to be understood that the current axle load can already be determined chronologically before the driving situation. The current axle load can thus be determined, for example, upon a vehicle activation, in particular also during a standstill of the vehicle, or during a straight-ahead journey of the vehicle which takes place chronologically before the driving situation. It is to be understood that the actual variable and the manipulated variable actual value are preferably determined at least partially simultaneously. The axle load on the steered steering axle corresponds particularly directly with the friction value, so that interfering influences in the approximation of the friction value can be reduced. However, it can also be provided, for example, that the load characteristic is a vehicle total load, a partial vehicle total load, a center of gravity location, a cargo weight of a cargo of the vehicle, and/or a mass distribution of the vehicle.

The approximation of the friction value preferably includes a selection of a corresponding reference friction value from a friction value database, which includes at least one reference friction value, based on the load characteristic and based on the manipulated variable deviation and/or the setpoint-actual deviation. The reference friction value is a friction value which was determined before the driving situation. The reference friction value corresponds to the current friction value if a reference load characteristic corresponding to the reference friction value is within a load tolerance around the determined load characteristic, and if a reference manipulated variable deviation is within the reference manipulated variable tolerance around the manipulated variable deviation, and/or a reference setpoint-actual deviation is within a reference setpoint-actual tolerance around the setpoint-actual deviation. A current friction value present in the driving situation can be approximated particularly easily via the above-described refinement of the method. The load characteristic, the setpoint-actual deviation, and/or the manipulated variable deviation, which are generally easily available during operation of the vehicle, can thus be used to reliably approximate the friction value. For example, the actual manipulated variable and the actual steering angle speed can be continuously determined by and available from the steering system of the vehicle. The selection is easily possible by using the parameter combination made up of manipulated variable, actual variable, and load characteristic. The friction value database preferably includes learned reference friction values. The reference friction values can be friction values approximated in driving situations chronologically preceding the driving situation, for example. Thus, for example, for a specific axle load, an associated steering torque, and a steering angle speed occurring as a result of the steering torque, a friction value can be approximated and this can then be stored as a reference friction value in the friction value database. The friction value database can also be entirely or partially based on test drives and/or prestored. The test drives can include, for example, a training procedure of an ESC, in particular with high friction value and low lateral dynamics of the vehicle. It is to be understood that the friction value database does not have to be based on a large number of test drives and/or does not have to include a very large number of friction values. Thus, for example, for multiple reference driving situations, which can also be driving situations occurring in normal operation of the vehicle, a maximum determined friction value for an axle load present in the reference driving situation can be stored. Assuming a linear dependence of the steering torque on the wheel load (or axle load) and an indirectly proportional dependence of the steering torque on a vehicle speed, further reference values can then be concluded. If the manipulated variable (steering torque) required to achieve an actual variable (actual steering angle speed) now deviates, for example, from a reference value thus determined, the current friction value can be concluded from the difference. The friction value database can thus be updated with little effort. The friction value database can thus be adapted with comparatively little effort to changes of the steering system and/or the tires of the vehicle.

In an embodiment, the method furthermore includes: determining at least one environmental indicator; wherein the selection of a reference friction value from the friction value database additionally takes place based on the environmental indicator. The environmental indicator represents environmental conditions, in particular weather conditions. The environmental indicator can be taken into consideration to improve the selection of the reference friction value.

The environmental indicator preferably is or represents a windshield wiper status of a windshield wiper of the vehicle, a current ambient temperature, the current date, and/or a geographical location of the vehicle. For example, the environmental indicator can be produced by evaluating a windshield wiper signal. A windshield wiper running at high frequency thus generally characterizes strong precipitation, which in turn causes a reduced friction value in comparison to dry ambient conditions. The ambient temperature, the date, and the geographical location, in particular in conjunction with a windshield wiper signal, permit conclusions, for example, about whether black ice is to be expected.

In an embodiment, the method furthermore includes a determination of a friction value database. The determination of the friction value database preferably includes: determining a reference friction value for a test cornering operation, which is chronologically prior to the driving situation; performing the test cornering operation; determining a reference load characteristic present in a test period of time; determining a reference setpoint variable for the test cornering operation; determining a reference manipulated variable expected value, which specifies a predicted value of a manipulated variable to be provided to set the reference setpoint variable on a steering system, wherein the determination of the reference manipulated variable expected value takes place using the reference load characteristic; determining a reference actual variable, corresponding to the reference setpoint variable, for the test cornering operation; determining a reference manipulated variable actual value for the test cornering operation; determining a reference manipulated variable deviation between the reference manipulated variable expected value and the reference manipulated variable actual values; and/or determining a reference setpoint-actual deviation between the reference setpoint variable and the corresponding reference actual variable; and assigning a parameter combination made up of the reference setpoint-actual deviation, the reference manipulated variable deviation, and the reference load characteristic to the reference friction value in the friction value database. In the determination of the friction value database, a corresponding parameter combination is thus preferably assigned to a known reference friction value.

According to various embodiment, the method preferably furthermore includes: detecting a control system intervention of a control system of the vehicle; determining a friction value using control system data which are provided by the control system; wherein the friction value is alternatively or additionally approximated based on the friction value if a control system intervention is detected. The control system is preferably a stability control system of the vehicle, in particular a so-called electronic stability control (ESC) and/or an antilock braking system (ABS) of the vehicle. Such stability control systems are provided in nearly all modern vehicles. Stability control systems determine a variety of control system data, which permits conclusions about the friction value or directly represent the friction value, in case of a control system intervention. The disclosure makes use of this in the preferred refinement.

According to an embodiment, the method furthermore includes: performing at least one following operation using the approximated friction value, wherein the following operation is or includes providing a warning signal, setting a stability control system into a preventative regulation mode; redetermining a trajectory of the vehicle, determining a movement degree of freedom limiting value, limiting a movement degree of freedom of the vehicle, and/or validating a friction value sensor. The following operation is preferably only performed if the approximated friction value falls below a friction value limiting value. A warning signal can thus only be output, for example, if the friction value falls below the friction value limiting value. This can be the case, for example, when the vehicle drives on an icy roadway. The warning signal is preferably an optical, acoustic, and/or haptic warning signal. However, it can also be provided that the warning signal is an electrical warning signal which is provided at a control unit of the vehicle. The trajectory includes at least one planned path, which is to be traveled by the vehicle to fulfill a driving task. Furthermore, the trajectory includes a driving-dynamics specification. This driving-dynamics specification preferably is or includes a predetermined speed for traveling on the path or a predetermined speed course for traveling on the path. The trajectory is determined by a fully autonomous or semiautonomous unit, such as an automatic distance control function or an autonomous control unit, which is also referred to as a virtual driver. The redetermination of the planned trajectory can be a complete redetermination of the planned trajectory, a partial redetermination of the planned trajectory, and/or update of the planned trajectory. A partial redetermination is provided, for example, when a path curve included by the planned trajectory or a path included by the trajectory is maintained and at the same time a corresponding speed profile for traveling the path curve, which is included by the planned trajectory, is redetermined. In the partial redetermination, preferably all information and/or data underlying the trajectory planning are determined again. In updating, preferably only some of the information and/or data underlying the trajectory planning are determined again. The determined friction value and/or the determined driving dynamics limiting value is preferably taken into consideration in the trajectory, wherein a level of safety when using the vehicle can be increased. Observing the driving dynamics limiting value ensures a safe and stable journey of the vehicle in normal operation. The driving dynamics limiting value preferably is or includes a maximum permitted vehicle speed, a maximum permitted transverse acceleration, a maximum permitted vehicle acceleration, a maximum permitted vehicle deceleration, a maximum permitted steering angle gradient, a maximum permitted steering frequency, or a minimum permitted curve radius of the vehicle. The friction value sensor is preferably an optical and/or acoustic friction value sensor.

In a second aspect, the disclosure achieves the object stated at the outset using a driver assistance system which is configured to carry out the method according to the first aspect of the invention. The driver assistance system preferably includes a control unit and an interface which can be connected to a vehicle network of the vehicle. The interface is preferably configured to receive vehicle signals which represent at least the load characteristic, the setpoint variable, the actual variable, the manipulated variable expected value, and/or the manipulated variable actual value. It is to be understood that one or more of the determination steps of the method can be performed by the driver assistance system based on such vehicle signals. The driver assistance system thus, for example, does not have to directly determine the load characteristic itself, but rather can also determine this based on load signals, for example, which are provided by an air suspension system of the vehicle on the vehicle network.

In a third aspect, the disclosure achieves the object stated at the outset by way of a vehicle having at least two axles, a braking system, a steering system, preferably an active steering system, and a driver assistance system according to the second aspect of the disclosure.

According to a fourth aspect of the disclosure, the object mentioned at the outset is achieved via a computer program product which has program code means that are stored on a computer-readable data carrier in order to carry out the method according to the first aspect of the disclosure when the computer program product is executed on a computing unit, in particular the control unit of the driver assistance system according to the second aspect of the disclosure.

It is to be understood that the driver assistance system according to the second aspect of the disclosure, the vehicle according to the third aspect of the disclosure, and the computer program product according to the fourth aspect of the disclosure have identical and similar sub-aspects, as are set forth for the method according to the first aspect of the disclosure.

### BRIEF DESCRIPTION OF DRAWINGS

The invention will now be described with reference to the drawings wherein:

FIG. 1 shows a top view of a schematically illustrated vehicle;

FIG. 2 shows a driving situation of the vehicle from FIG. 1 illustrated as a cornering operation;

FIG. 3 shows a schematic flow chart of a method for approximating a friction value;

FIG. 4 shows a schematic flow chart which illustrates a determination of a selection of a reference friction value and an upstream determination of a friction value database; and,

FIG. 5 shows a schematic flow chart which illustrates performing a following operation following the approximation of the friction value.

### DETAILED DESCRIPTION

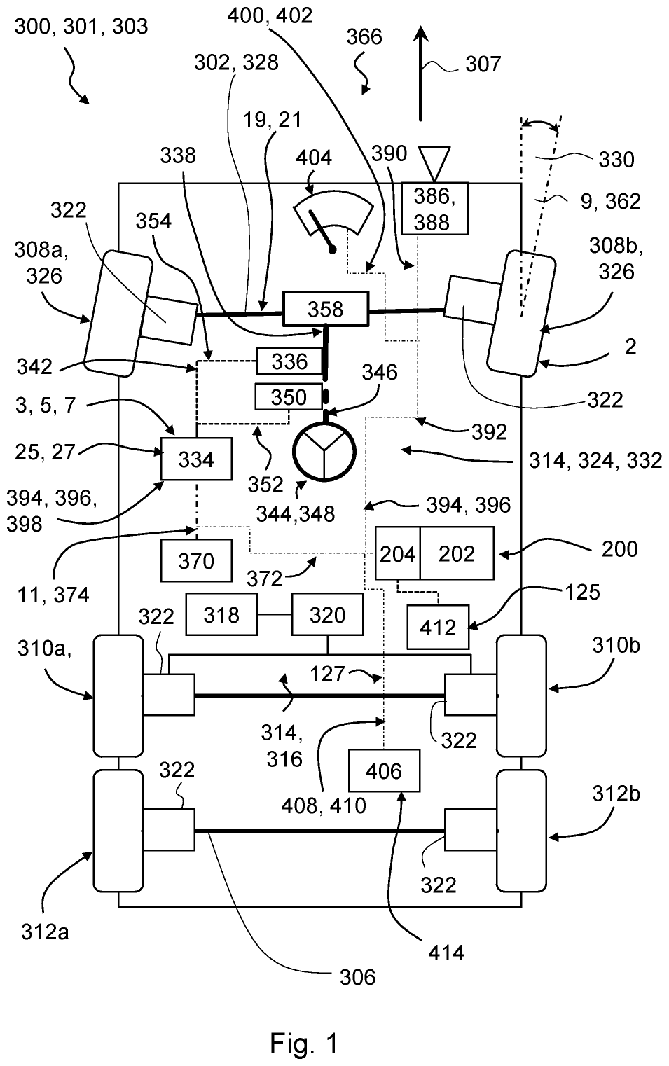

FIG. 1 shows a vehicle 300, which is configured as a three-axle utility vehicle 301. The vehicle 300 additionally includes, in addition to a front axle 302 and a rear axle 304, a liftable auxiliary axle 306, which is arranged behind the rear axle 304 in the direction of travel 307. The liftable auxiliary axle 306 (lift axle 306 in short) can be raised or lifted so that the mass of the vehicle 300 or a weight force resulting from the load is distributed only onto front wheels 308 of the front axle 302 and rear wheels 310 of the rear axle 304. When the lift axle 306 is lowered, the weight force of the vehicle 300 is additionally distributed onto auxiliary wheels 312 of the lift axle 306.

The vehicle 300 includes multiple vehicle actuators 314, which are configured to influence the vehicle 300 in its longitudinal dynamics and transverse dynamics. For this purpose, the vehicle actuators 314 influence multiple movement degrees of freedom of the vehicle 300. A braking system 316 is provided for braking the vehicle 300, which includes a brake control unit 318, a brake modulator 320, and multiple brake actuators 322. The brake actuators 322 are assigned to the wheels 308, 310, 312 of the vehicle 300 and are configured to provide a braking torque 313 at the wheels 308, 310, 312. For reasons of illustration, only the brake actuators 322 of the rear wheels 310 are connected to the brake modulator 320 in FIG. 1. To brake the vehicle 300, the brake module 320 provides a brake pressure at the brake actuators 322, which thereupon modulates a brake slip at the wheels 308, 310, 312 of the vehicle 300.

As a further vehicle actuator 314, the vehicle 300 includes a steering system 324. The steering system 324 is configured to control steered wheels 326 of a steerable axle 328 of the vehicle 300 or to modulate a steering angle 330 at the steered wheels 326. In the utility vehicle 301 according to FIG. 1, the front axle 302 represents the steerable axle 328, so that the front wheels 308a, 308b are the steered wheels 326. However, for example, it can also be provided that the auxiliary wheels 312 of the auxiliary axle 312 are steerable, wherein the auxiliary axle 312 is then usually not liftable.

The steering system 324 is an active steering system 332 here, thus an at least partially electronic steering system 332. The setting of the steering angle 330 at the steerable wheels 326 does not take place solely mechanically in the active steering system 332, but rather at least partially based on electrical signals. For this purpose, the active steering system 332 includes a steering control unit 334, which is connected to a servomotor 336. The servomotor 336 is arranged on a steering column 338 of the steering system 324 and is configured to provide a steering torque at the steering column 338. For example, an output shaft (not shown in the figures) of the servomotor 336 is connected for this purpose to the steering column 338 via a gearing. To provide the steering torque, the servomotor 336 receives corresponding servomotor control signals 342 from the steering control unit 334. The servomotor control signals 342 can be provided directly in the form of a positioning current or a positioning voltage at the servomotor 336. However, it can also be provided that the servomotor 336 includes a servomotor controller, which receives servomotor control signals 342 and provides a corresponding positioning current or a corresponding positioning voltage. The steering control unit 334 can thus steer the vehicle 300 via the servomotor 336.

The partially electronic steering system 332 is controllable not only via the steering control unit 334, but also manually. For this purpose, the steering system 324 includes a steering wheel 344, which is connected via a torsion rod 346 to the steering column 338. A manual torque 348 provided by a human driver via the steering wheel 344 can be metrologically detected using the torsion rod 346 via a manual torque sensor 350. The manual torque sensor 350 detects a torsion of the torsion rod 346 and provides a corresponding manual torque signal 352. For this purpose, the manual torque sensor 350 is connected to the steering control unit 334. Furthermore, in the embodiment shown, the servomotor 336 also reports a provided servomotor torque signal 354 back to the steering control unit 334. The steering control unit 334 can determine, using the servomotor torque signal 354 and the manual torque signal 352, a resulting steering torque 3 of the steering system 324 of the vehicle 300. The steering torque 3 is the sum of the manual torque 348, which is applied manually via the steering wheel 344, and a torque provided by the servomotor 336. In this case, the steering control unit 334 furthermore considers a torque boost which is provided by a hydraulic steering torque booster 358. The steering torque booster 358 receives the manual torque 348 and the torque of the servomotor 336 as the input and modulates a steering torque 3 at the steered wheels 326, which is amplified by a predetermined amplification factor.

The steering torque 3 is a manipulated variable 5 of the steering system 324, the specification of which results in the modulation of the steering angle 330. The steering angle 330 can be determined by the steering control unit 334. A chronological rate of change of the steering angle 330 is a so-called steering angle speed 7, which can also be determined here by the steering control unit 334. The steering angle speed 7 thus specifies by which amount the steering angle 330 changes per observed period of time. In the preferred embodiment, the steering angle speed 7 has a value of the unit degrees per second (°/s). Accordingly, if a steering angle speed 7 of 10°/s is present at the steered wheels 326 for 2 seconds, the steering angle 330 changes within the observed period of time of 2 seconds by 20°.

In the embodiment shown, the steering control unit 334 is configured to determine both the manipulated variable 5, which is the steering torque 3 here, and an actual variable 9 caused by specification of the manipulated variable at the steering system 324, which is the steering angle speed 7 here. The vehicle 300 travels on a roadway 366, wherein a friction contact exists between the wheels 308, 310, 312 of the vehicle 300 and the roadway 366. A friction value 2 between the roadway 366 and the steered wheels 326 of the vehicle 300 decisively influences which steering angle speed 7 is achieved upon specification of a steering torque 3. With low friction and accordingly also low friction value 2 between the roadway 366 and the steered wheels 326, a significantly lower steering torque 3 thus has to be provided to achieve the steering angle speed 7 of 10°/s than if a high friction value 2 is present between the roadway 366 and the steered wheels 326. Upon provision of the same manipulated variable 5 at the steering system 324, different actual variables 9 can thus also be modulated for various friction values 2 between the roadway 366 and the steered wheels 326. Thus, for example, an icy roadway 366 opposes a rotation of the steered wheels 326 with a significantly lower torque to be overcome than a dry, rough roadway 366. A control behavior of the vehicle 300 is decisively determined by the friction value 2 present between the wheels 308, 310, 312 of the vehicle 300 and the roadway 300.

The vehicle 300 is a semiautonomous vehicle 300 here and includes an autonomous unit 370, which is configured to control the vehicle 300. The autonomous unit 370 is connected via a vehicle network 372, which is a CAN bus system here, to the steering control unit 334. To control the vehicle 300, the autonomous unit 370, which can also be referred to as a virtual driver, provides control signals 374 on the vehicle network 372. The steering control unit 334 receives the control signals 374 from the vehicle network 372 and controls the servomotor 336 based on the control signals 374 so that a steering torque 3 corresponding to the control signals 374 is modulated. The control signals 374 include a setpoint variable 11. In the observed embodiment, the autonomous unit 370 provides a setpoint steering angle speed 13 on the vehicle network 372 as the setpoint variable 11. This setpoint steering angle speed 13 is a steering angle speed which the autonomous unit 370 specifies for a driving situation 15.

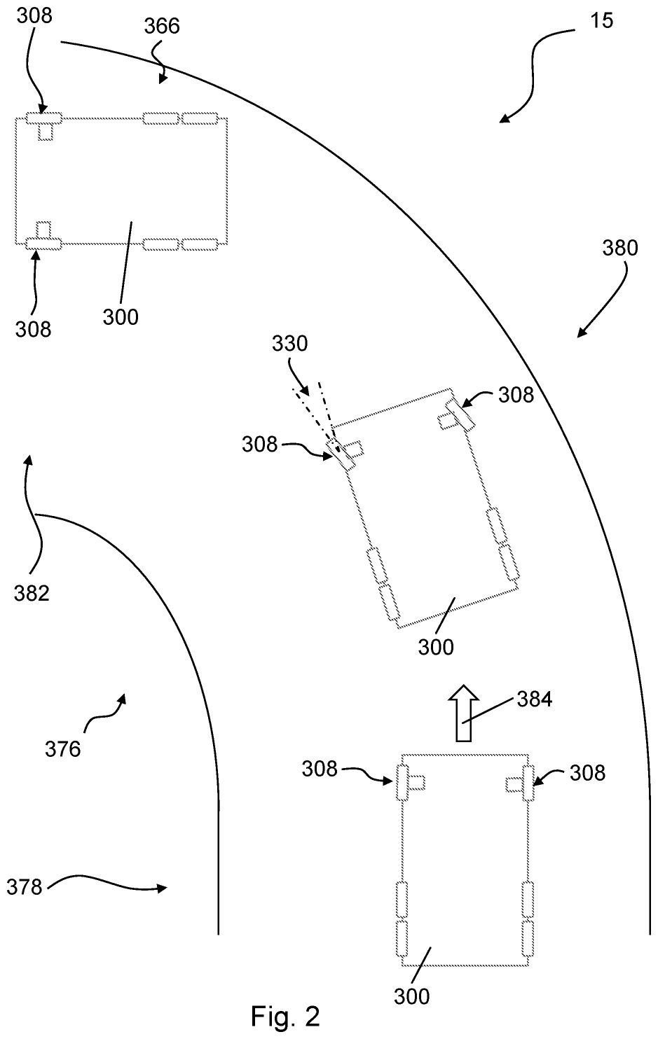

The driving situation 15 is illustrated as a cornering operation of the vehicle 300 by way of example in FIG. 2. FIG. 2 shows the vehicle 300 at multiple positions in a curve 376 and is thus supposed to represent a course over time of the driving situation 15. At a curve entry 378, the front wheels 308 of the vehicle are still aligned straight, so that the steering angle 330 has a value of 0°. At a curve vertex 380, a steering angle 330 greater than 0° (in the example shown approximately 20°) is modulated at the front wheels 308 of the vehicle 300. This steering angle 330 is then reduced again in the direction of a curve exit 382, so that the front wheels 308 again have a steering angle 330 of 0° at the curve exit 382. The autonomous unit 370 specifies here as a setpoint steering angle speed 13 a steering angle speed which is required according to a prediction, which is performed by the autonomous unit 370, to travel through the curve 376. Between curve beginning 378 and curve vertex 380, the steering angle speed has a positive value, since the steering angle 330 increases. Analogously, the steering angle speed has a negative value between curve vertex 380 and curve exit 382.

The autonomous unit 370 specifies as the setpoint steering angle speed 13 a steering angle speed which it expects for the driving situation 15. The setpoint steering angle speed 13 is selected here so that the vehicle 300 follows the curve 376 and moves within defined boundaries of the roadway 366. Furthermore, the autonomous unit 370 also actuates a drive motor (not shown in the figures) of the vehicle 300 so that the vehicle 300 is guided in the driving situation 15 at a safe speed 384 through the curve 376. For this purpose, the autonomous unit 370 determines the setpoint steering angle speed 13 and the speed 384 required for the driving situation 15 beforehand. This prediction is based in the embodiment shown, among other things, on the friction value 2 between the steered wheels 326 and the roadway 366. If the real existing friction value 2 now deviates from the friction value 2 taken into consideration in the context of determining the setpoint steering angle speed 13, it is then possible that the vehicle 300 cannot follow the curve 376. There is a significant risk of accident in this way, since the autonomous unit 370 does not suitably control the vehicle 300 under certain circumstances. For example, the autonomous unit 370 can control the vehicle 300 at significantly excessive speed 384 in the curve 376, wherein the vehicle 300 cannot follow the course of the curve 376 under certain circumstances with icy roadway 366 and can be carried out of the curve 376. The knowledge of the friction value 2 is therefore important for safe operation of the vehicle 300.

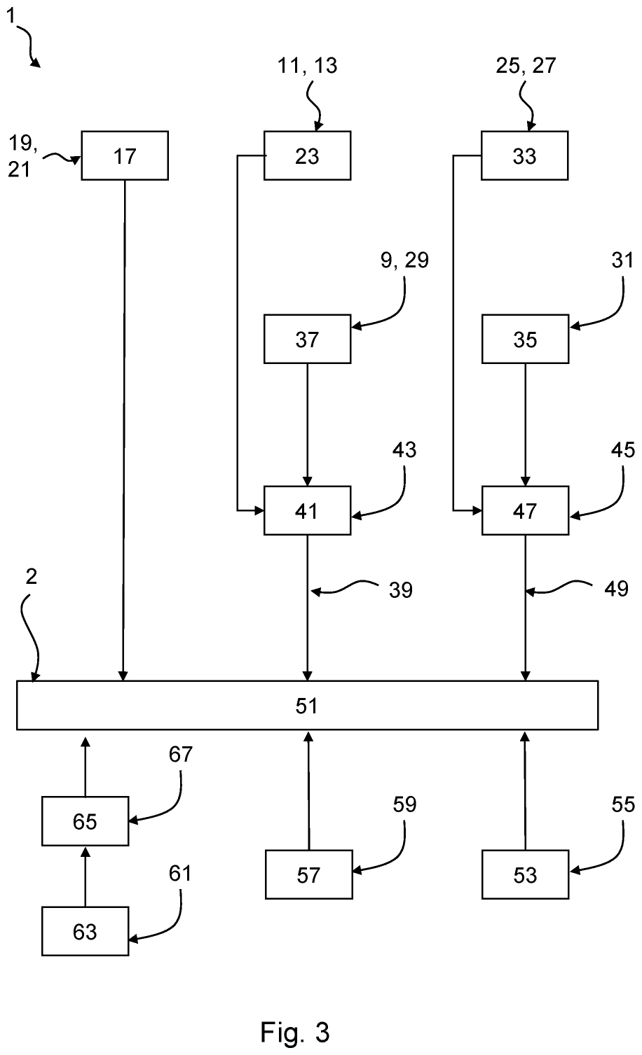

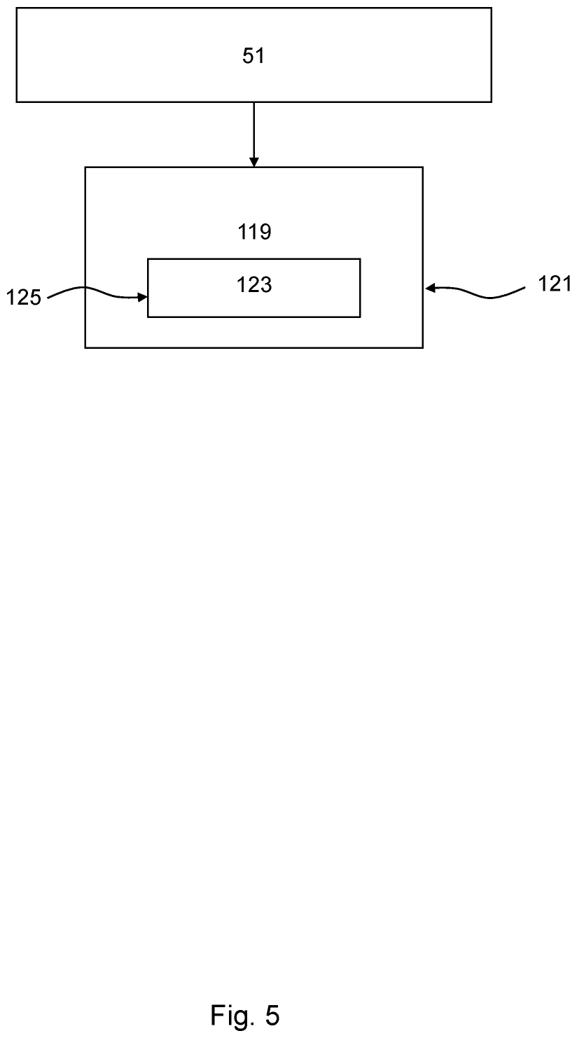

To determine the friction value 2, the vehicle 300 includes an optical sensor 386, which is configured here as the camera 388 capturing the roadway 366. However, the optical sensor 386 has the disadvantage that the friction value 2 can only be determined in sufficiently good light conditions. Therefore, the vehicle 300 in the embodiment shown additionally includes a driver assistance system 200, which is configured to carry out the method 1 explained hereinafter with reference to FIG. 3 to FIG. 5 for approximating a friction value 2 between wheels 308, 310, 312 of the vehicle 300 and the roadway 366. The driver assistance system 200 can furthermore also verify a friction value 2 determined by the optical sensor 386. However, it is to be understood that the vehicle 300 can also only include the driver assistance system 200 and no optical sensor 386.

The driver assistance system 200 includes a control unit 202 and an interface 204. The interface 204 is connected to the vehicle network 372 and also receives sensor signals 390 of the optical sensor 386 via this in order to then verify these signals.

In a first step of the method 1 for approximating a current friction value 2 between the wheels 308, 310, 312 of the vehicle 300 in a current vehicle configuration 303 and the roadway 366, a determination 17 of a load characteristic 19 of the current vehicle configuration 303 takes place. The current vehicle configuration 303 considers a current loading of the vehicle 300. The load characteristic 19 of the current vehicle configuration 303 is, in the present embodiment, an axle load 21 on the steerable axle 328 of the vehicle 300. In addition to an intrinsic weight of the vehicle 300, among other things, the axle load 21 also results from its loading. The axle load 21 corresponds to a normal force acting in the direction of the roadway 366 on the steered wheels 326, which in turn decisively influences the friction value 2. Lightly loaded wheels 326 can thus turn significantly more easily on the roadway 366 in otherwise identical conditions than strongly loaded wheels 326. A quality of the approximation of the friction value 2 can be improved by the consideration of the axle load 21. The axle load 21 is determined by an air suspension system (not shown in the figures) of the vehicle 300, wherein the air suspension system provides axle load signals 392 representing the axle load 21 on the vehicle network 372. The control unit 202 carries out the determination 17 of the load characteristic 19 using these axle load signals 392. Signals already present on the vehicle network 372 can thus advantageously be used for the determination 17. The method 1 is particularly easily implementable.

As already explained above, the autonomous unit 370 determines the setpoint variable 11 for the driving situation 15, which is the setpoint steering angle speed 13 here, and provides it on the vehicle network 372. For this purpose, the autonomous unit 370 preferably also takes into consideration the axle load 21 or other load characteristics of the vehicle 300. The control unit 202 of the driver assistance system 200 determines, in a further step of the method 1 using corresponding signals which are provided on the vehicle network 372, the setpoint variable 11 (determination 23 in FIG. 3). However, it can also be provided that the control unit 202 determines the setpoint variable 11 directly.

The setpoint steering angle speed 13 is available at the control unit 202 and at the steering control unit 334. The steering control unit 334 determines a manipulated variable expected value 25, which is a steering torque expected value 27 here, from the provided setpoint steering angle speed 13. The steering control unit 334 initially modulates a steering torque 3, which corresponds to the steering torque expected value 27, as the manipulated variable 5 to achieve an actual steering angle speed 29 (actual variable 9), which corresponds to the setpoint steering angle speed 13. At the beginning of the driving situation 15, the manipulated variable 5 thus corresponds here to a manipulated variable expected value 25. However, if the friction value, based on which the steering torque expected value 27 is determined, now deviates from the real friction value 2, an actual steering angle speed 29 different from the setpoint steering angle speed 13 then results from the provided steering torque 3. The steering control unit 334 thereupon adjusts the provided steering torque 3 or manipulated variable 5 until the actual steering angle speed 29 corresponds to the setpoint steering angle speed 13. For example, in case of an icy roadway 366, the steering control unit 334 reduces the steering torque 3 provided at the steering column 338, since the steered wheels 326 turn more easily on the roadway 366 due to a low friction value 2. A manipulated variable actual value 31, which is an actual value of the steering torque 3, therefore deviates in the embodiment shown from the manipulated variable expected value 25. The steering control unit 334 provides expected value signals 394 corresponding to the manipulated variable expected value 25 and manipulated variable actual value signals 396 corresponding to the manipulated variable actual value 31 on the vehicle network 372.

The control unit 202 of the driver assistance system 200 receives the expected value signals 394 and carries out a determination 33 of the manipulated variable expected value 25 using the expected value signals 394. Analogously, the control unit 202 receives the manipulated variable actual value signals 396 and uses them to determine 35 the manipulated variable actual value 31. The determination 35 of the manipulated variable actual value 31 takes place chronologically after the determination 33 of the manipulated variable expected value 25 here, but in principle can also take place at the same time as or before the determination 33. In the present embodiment, the steering control unit 334 itself readjusts the manipulated variable 5 so that the actual variable 9, which is the actual steering angle speed 29 here, corresponds to the target steering angle speed 13. For this purpose, the steering control unit 334 continuously determines the value of the actual variable 9 (the actual steering angle speed 29) and provides corresponding actual signals 398 on the vehicle network 372. In addition to the signals 394, 396, which relate to the manipulated variable 5, in the embodiment shown, the steering control unit 334 also receives the actual signals 398 and determines the actual variable 9 therefrom in a determination 37.

The setpoint variable 11 and the manipulated variable expected value 25 can already be determined (determination 23, 33) before the vehicle 300 is actually in the driving situation 15. The determination 23, 33 of the setpoint variable 11 and the manipulated variable expected value 25 can accordingly already be performed in the observed embodiment before the vehicle 300 travels through the curve 376. During or also after the driving situation 15, the control unit 202 can furthermore determine the actual variable 9 relating to the actual vehicle status of the vehicle 300 and the manipulated variable actual value 31 for the driving situation (determination 35, 37 in FIG. 3). Two pairs of variables corresponding to one another are thus present at the control unit 202 of the driver assistance system 200. A first pair is the setpoint variable 11 and the associated actual variable 9 actually occurring in the driving situation 15. The manipulated variable expected value 25 and the manipulated variable actual value 31 actually provided in the driving situation 15 at the steering system 324 form a second pair of variables corresponding to one another.

As was already described above, the steering control unit 334 controls the steering torque 3 so that the actual variable 9 in the driving situation 15 substantially corresponds to the setpoint variable 11. The actual steering angle speed 29 is within a setpoint-actual tolerance 39 around the setpoint steering angle speed 13. A setpoint-actual deviation 43, determined in the context of a determination 41, between the actual variable 9 and the setpoint variable 11 (first pair of variables corresponding to one another) is therefore negligible in the present embodiment of the method 1, wherein the setpoint-actual tolerance 39 is taken into consideration here in order to compensate for measurement errors included by the actual signals 398. A manipulated variable deviation 45, caused by the tracking of the actual variable 9 to the setpoint variable 11, between the manipulated variable expected value 25 and the manipulated variable actual value 31 is determined in a further step of the method 1 (determination 47 in FIG. 3). In the present embodiment, the manipulated variable deviation 45 thus lies outside a manipulated variable tolerance 49 around the manipulated variable expected value 25, while the setpoint-actual deviation 43 can be neglected. However, it is to be understood that the setpoint-actual deviation 43 can also have a substantial value. This can be the case, for example, if the manipulated variable 5 is not readjusted fast enough or if the manipulated variable 5 cannot be readjusted so that the actual variable 9 corresponds to the setpoint variable 11.

Based on the manipulated variable deviation 45, the setpoint-actual deviation 43, and the determined load characteristic 19, in a subsequent step of the method 1, an approximation 51 of the current friction value 2 is performed. In the observed embodiment, the control unit 202 of the driver assistance system 200 determines the friction value 2 from the manipulated variable deviation 45, which is a difference of the steering torque expected value 27 and the steering torque 3 actually modulated in the driving situation 15, and the axle load 21, wherein the control unit 202 takes into consideration here that the setpoint-actual deviation 43 is negligible. The quality of the approximation 51 is improved by the use of the load characteristic 19, since in this way a contact pressure force of the steered wheels 326 on the roadway 366 is taken into consideration.

In the observed embodiment, the method 1 furthermore includes a determination 53 of an environmental indicator 55, which is taken into consideration in the approximation 51 of the friction value 2. The control unit 202 of the driver assistance system 200 carries out the determination 53 of the environmental indicator 55 based on environmental signals 400, which are windshield wiper signals 402 here. A windshield wiper 404 of the vehicle 300 according to FIG. 1 provides the windshield wiper signals 402 on the vehicle network 372, so that they can be received by the control unit 202. The windshield wiper signals 402 represent a windshield wiper status of the windshield wiper 404 and thus permit inferences about an amount of precipitation prevailing in the driving situation 15. For example, the windshield wiper 404 generally runs at higher frequency when the precipitation is high, which in turn represents a low friction value 2.

Furthermore, the method 1 in the embodiment shown includes a determination 57 of a lateral acceleration 59 of the vehicle 300 in the driving situation 15. A control system 406 of the vehicle 300, which is an electronic stability control here, intervenes in a stabilizing manner in case of instabilities of the vehicle 300. The control system 406 thus causes, for example, to generate a yaw torque acting toward the inside of the curve, the wheels 308, 310, 312 of the vehicle 300 on the inside of the curve to be braked more strongly than the wheels 308, 310, 312 on the outside of the curve when the vehicle 300 understeers. To be able to trigger such interventions reliably, the control system 406 continuously detects the lateral acceleration 59 present on the vehicle 300 and provides corresponding control system signals 408 on the vehicle network 372. These control system signals 408 can be used by the control unit 202 of the driver assistance system 200 to carry out the determination 57 of the lateral acceleration 59 of the vehicle 300 in the driving situation 15. The determined lateral acceleration 59 is then additionally used in the approximation 51 of the current friction value 2.

Furthermore, the driver assistance system 200 can detect a control system intervention 61 of the control system 406 based on the stability signals 408 of the control system 406 (detection 63 in FIG. 3). The control system signals 408 include control system data 410 which are used in a determination 65 to determine a friction value 67 between the wheels 308, 310, 312 of the vehicle 300 and the roadway 366. The control system 406 carries out control system interventions 61 when the vehicle 300 is unstable. This is usually the case when sufficient forces cannot be transmitted between vehicle 300 and roadway 366, so that the friction value 67 available in these driving situations 15 is not sufficient. The control system signals 408 can therefore advantageously be used to determine 65 the friction value 67. For example, a lateral acceleration which still just enables a stable journey for a known axle load of the vehicle 300 (that is, a lateral acceleration shortly before the occurrence of an instability) can be used to conclude the friction value 67. Preferably, however, in addition to the friction value 67, the setpoint-actual deviation 43, the load characteristic 19, and/or the manipulated variable deviation 45 are used to approximate 51 the friction value 2.

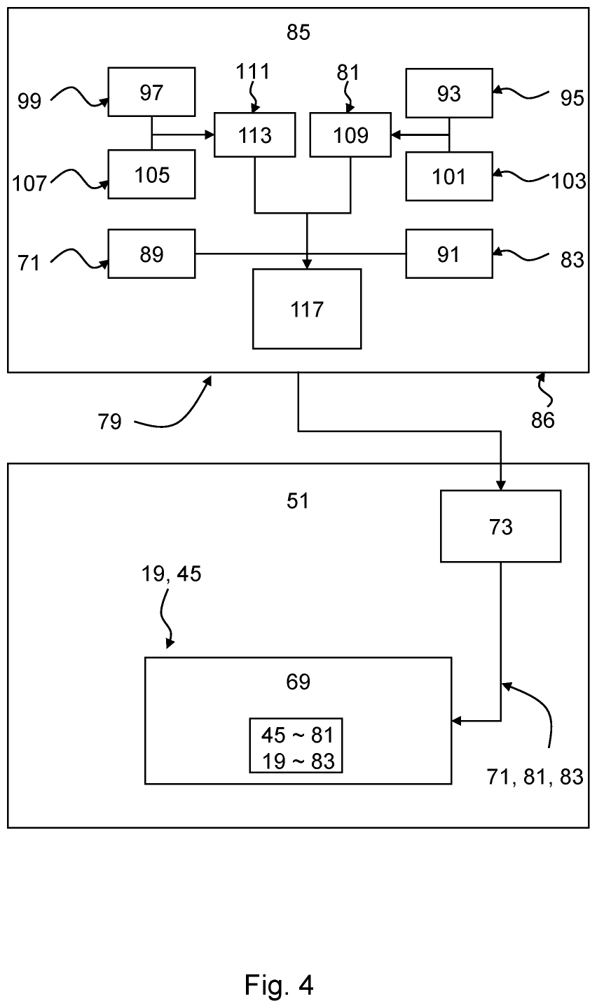

According to FIG. 4, the approximation 51 of the current friction value 2 is a selection 69 of a reference friction value 71 from a friction value database 79. In the present embodiment, a plurality of reference friction values 71, which were stored for a plurality of earlier driving situations, are stored in the friction value database 79. In the selection 69, a current friction value 2 is determined in that a reference friction value 71 is selected to which a reference manipulated variable deviation 81 is assigned, which substantially corresponds to the manipulated variable deviation 45, and to which a reference load characteristic 83 is assigned, which substantially corresponds to the load characteristic 19 of the vehicle 300 prevailing in the driving situation 15. A required degree of the correspondence of reference manipulated variable deviation 81 and manipulated variable deviation 45 or reference load characteristic 83 and load characteristic 19 can be defined depending on a size of the friction value database 79. A reference friction value 71 can thus be selected as the friction value 2, for example, the reference load characteristic 83 of which deviates by 20% from a value of the load characteristic 19 if the friction value database 79 is small. In contrast, if the friction value database 79 includes very many reference friction values 71, a reference friction value 71 can then only be selected as the friction value 2, for example, if its reference load characteristic 83 deviates at most by 5% from a value of the load characteristic 19.

Prior to the selection 69, the method 1 furthermore includes a determination 85 of the friction value database 79. In this determination 85, a test cornering operation 86 of the vehicle 300 is performed (performance 87 in FIG. 4). The test cornering operation 86 can alternatively also be performed using a comparison vehicle 300, however. The comparison vehicle 300 can be, for example, a vehicle which is of the same vehicle type as the vehicle 300 according to FIG. 1. A reference friction value 71 for the test cornering operation 86 is determined separately in the context of a determination 89 and is at least approximately known for the test cornering operation 86. In the context of the test cornering operation 86, a determination 91 of a reference load characteristic 83 present in a test period of time, a determination 93 of a reference manipulated variable expected value 95, a determination 97 of a reference setpoint variable 99 for the test cornering operation 86, a determination 101 of a reference manipulated variable actual value 103 for the test cornering operation 86, and a determination 105 of a reference actual variable 107 for the test cornering operation 86 take place. The reference manipulated variable deviation 81 can be determined subsequently thereto in a determination 109 from the reference manipulated variable actual value 103 and the reference manipulated variable expected value 95. A reference setpoint-actual deviation 111 is determined in a determination 113 based on the reference setpoint variable 99 and the reference actual variable 107. The reference setpoint-actual deviation 111, the reference manipulated variable deviation 81, and the reference load characteristic 83 are then assigned to the reference friction value 71 (assignment 117 in FIG. 4).

In the embodiment of the method 1, the current friction value 2 is used subsequently to the determination 51 to perform 119 a following operation 121. The following operation 121 here is a provision 123 of a warning signal 125 at a warning light 412 of the vehicle 300. Furthermore, an electrical warning signal 127 is provided by the control unit 202 of the driver assistance system 200 on the vehicle network 372. The electrical warning signal 127 is thus also present at the autonomous unit 370 and can be used thereby to determine a trajectory. Furthermore, the control system 406 can be put into a preventative control mode 414 via the electrical warning signal 127, in which the stability control system 380 can detect and compensate for any instabilities of the vehicle 300 early. In the present embodiment, the stability control system 380 is only put into the preventative control mode 414, however, if the current friction value 2 falls below a friction value limiting value. Stabilizing interventions of the control system 406 are thus usually only necessary if the current friction value 2 is comparatively small, as is the case, for example, with icy roadway 366.

It is understood that the foregoing description is that of the preferred embodiments of the invention and that various changes and modifications may be made thereto without departing from the spirit and scope of the invention as defined in the appended claims.

Reference signs (part of the description)

| | |
|---|---|
| 1 | method |
| 2 | friction value |
| 3 | steering torque |
| 5 | manipulated variable |
| 7 | steering angle speed |
| 9 | actual variable |
| 11 | setpoint variable |
| 13 | setpoint steering angle speed |
| 15 | driving situation |
| 17 | determining a load characteristic |
| 19 | load characteristic |
| 21 | axle load |
| 23 | determining the setpoint variable |
| 25 | manipulated variable expected value |
| 27 | steering torque expected value |
| 29 | actual steering angle speed |
| 31 | manipulated variable actual value |
| 33 | determining the manipulated variable expected value |
| 35 | determining the manipulated variable actual value |
| 37 | determining the actual variable |
| 39 | setpoint-actual tolerance |
| 41 | determining a setpoint-actual deviation |
| 43 | setpoint-actual deviation |
| 45 | manipulated variable deviation |
| 47 | determining the manipulated variable deviation |
| 49 | manipulated variable tolerance |
| 51 | approximating the friction value |
| 53 | determining an environmental indicator |
| 55 | environmental indicator |
| 57 | determining a lateral acceleration |
| 59 | lateral acceleration |
| 61 | control system intervention |
| 63 | detecting a control system intervention |
| 65 | determining a friction value |
| 67 | friction value |
| 69 | selecting a reference friction value |
| 71 | reference friction value |
| 79 | friction value database |
| 81 | reference manipulated variable deviation |
| 83 | reference load characteristic |
| 85 | determining the friction value database |
| 86 | test cornering operation |
| 87 | performing the test cornering operation |
| 89 | determining the reference friction value |
| 91 | determining the reference load characteristic |
| 93 | determining a reference manipulated |
| | variable expected value |
| 95 | reference manipulated variable expected value |
| 97 | determining a reference setpoint variable |
| 99 | reference setpoint variable |
| 101 | determining a reference manipulated |
| | variable actual value |
| 103 | reference manipulated variable actual value |
| 105 | determining a reference actual variable |
| 107 | reference actual variable |
| 109 | determining the reference manipulated |
| | variable deviation |
| 111 | reference setpoint-actual deviation |
| 113 | determining the reference setpoint-actual deviation |
| 117 | assigning to a reference friction value |
| 119 | performing a following operation |
| 121 | following operation |
| 123 | providing a warning signal |
| 125 | warning signal |
| 127 | electrical warning signal |
| 200 | driver assistance system |
| 202 | control unit |
| 204 | interface |
| 300 | vehicle |
| 301 | utility vehicle |
| 302 | front axle |
| 303 | current vehicle configuration |
| 304 | rear axle |
| 306 | auxiliary axle |
| 307 | direction of travel |
| 308, 308a, | front wheels |
| 308b | |
| 310 | rear wheels |
| 312 | auxiliary wheels |
| 313 | braking torque |
| 314 | vehicle actuator |
| 316 | braking system |
| 318 | brake control unit |
| 320 | brake modulator |
| 322 | brake actuator |
| 324 | steering system |
| 326 | steered wheels |
| 328 | steerable axle |
| 330 | steering angle |
| 332 | active steering system |
| 334 | steering control unit |
| 336 | servomotor |
| 338 | steering column |
| 342 | servomotor control signals |
| 344 | steering wheel |
| 346 | torsion bar |
| 348 | manual torque |
| 350 | manual torque sensor |
| 352 | manual torque signal |
| 354 | servomotor torque signal |
| 358 | steering torque booster |
| 366 | roadway |
| 370 | autonomous unit |
| 372 | vehicle network |
| 374 | control signals |
| 376 | curve |
| 378 | curve entry |
| 380 | curve vertex |
| 382 | curve exit |
| 384 | speed |
| 386 | optical sensor |
| 388 | camera |
| 390 | sensor signals |
| 392 | axle load signals |
| 394 | expected value signals |
| 396 | manipulated variable actual value signals |
| 398 | actual signals |
| 400 | environmental signals |
| 402 | windshield wiper signals |
| 404 | windshield wiper |
| 406 | control system |
| 408 | control system signals |
| 410 | control system data |
| 412 | warning light |
| 414 | control mode |

1. A method for approximating a friction value between wheels of a vehicle in a current vehicle configuration and a roadway, the method comprising:
determining at least one load characteristic of the current vehicle configuration;
determining a setpoint variable of the vehicle for a driving situation;
determining a manipulated variable expected value, which specifies a predicted value of a manipulated variable to be provided to set the manipulated variable at a steering system, wherein the determination of the manipulated variable expected value is performed using the at least one load characteristic;
determining an actual variable corresponding to the setpoint variable in the driving situation;
determining a manipulated variable actual value, which is provided in the driving situation at the steering system, in order to modulate the actual variable;
determining at least one of a manipulated variable deviation between the manipulated variable expected value and the manipulated variable actual value and a setpoint-actual deviation between the setpoint variable and the corresponding actual variable; and,
approximating the friction value based on the determined at least one load characteristic and based on the determined at least one of the manipulated variable deviation and the setpoint-actual deviation.

2. The method of claim 1, wherein the setpoint variable is or includes a setpoint steering angle speed of the vehicle; and, the actual variable is or includes an actual steering angle speed.

3. The method of claim 1, wherein the manipulated variable is or includes a steering torque provided at the steering system.

4. The method of claim 1 further comprising determining a lateral acceleration of the vehicle in the driving situation.

5. The method of claim 4, wherein said approximating the friction value is additionally performed based on the determined lateral acceleration.

6. The method of claim 4, wherein said approximating the friction value only takes place if the lateral acceleration is below a lateral acceleration limiting value.

7. The method of claim 1, wherein the load characteristic is a current axle load of a steering axle of the vehicle steered by the steering system.

8. The method of claim 1, wherein said approximating the friction value includes:
selecting a corresponding reference friction value from a friction value database, which includes at least one reference friction value, based on the at least one load characteristic and based on the determined at least one of the manipulated variable deviation and the setpoint-actual deviation.

9. The method of claim 8 further comprising:
determining at least one environmental indicator; and,
wherein said selecting the reference friction value from the friction value database additionally takes place based on an environmental indicator.

10. The method of claim 9, wherein the environmental indicator is or represents at least one of a windshield wiper status of a windshield wiper of the vehicle, a current ambient temperature, a current date, and a geographical location of the vehicle.

11. The method of claim 8 further comprising determining the friction value database.

12. The method of claim 11, wherein said determining the friction value database includes:
determining the reference friction value for a test cornering operation, which is chronologically prior to the driving situation;
performing the test cornering operation;
determining a reference load characteristic present in a test period of time;
determining a reference setpoint variable for the test cornering operation;
determining a reference manipulated variable expected value, which specifies the predicted value of the manipulated variable to be provided to set the reference setpoint variable at the steering system;
determining a reference actual variable corresponding to the reference setpoint variable for the test cornering operation;
determining a reference manipulated variable actual value for the test cornering operation;
determining at least one of a reference manipulated variable deviation between the reference manipulated variable expected value and the reference manipulated variable actual value and a reference setpoint-actual deviation between the reference setpoint variable and the corresponding reference actual variable; and,
assigning a parameter combination made up of the reference setpoint-actual deviation, the reference manipulated variable deviation and the reference load characteristic to the reference friction value in the friction value database.

13. The method of claim 12, wherein said determining the reference manipulated variable expected value takes place using the reference load characteristic.

14. The method of claim 1 further comprising:
detecting a control system intervention of a control system of the vehicle;
determining the friction value using control system data, which are provided by the control system; and,
wherein the approximation of the friction value alternatively or additionally takes place based on the friction value if the control system intervention is detected.

15. The method of claim 1 further comprising:
performing at least one following operation using the approximated friction value, wherein:
the following operation is or includes providing a warning signal, setting a control system into a preventative control mode, and at least one of redetermining a trajectory of the vehicle, determining a movement degree of freedom limiting value, limiting a movement degree of freedom of the vehicle, and validating a friction value sensor.

16. The method of claim 15, wherein the following operation is only performed if the approximated friction value falls below a friction value limiting value.

17. A driver assistance system for a vehicle, wherein the driver assistance system is configured to carry out the method of claim 1.

18. A vehicle comprising:
at least two axles;
a braking system;
a steering system;
a driver assistance system including a processor and a non-transitory computer readable medium having program code for approximating a friction value between wheels of the vehicle in a current vehicle configuration and a roadway stored thereon;
said program code being configured, when executed by said processor, to:
determine at least one load characteristic of the current vehicle configuration;
determine a setpoint variable of the vehicle for a driving situation;
determine a manipulated variable expected value, which specifies a predicted value of a manipulated variable to be provided to set the manipulated variable at said steering system, wherein the determination of the manipulated variable expected value is performed using the at least one load characteristic;
determine an actual variable corresponding to the setpoint variable in the driving situation;
determine a manipulated variable actual value, which is provided in the driving situation at said steering system, in order to modulate the actual variable;
determine at least one of a manipulated variable deviation between the manipulated variable expected value and the manipulated variable actual value and a setpoint-actual deviation between the setpoint variable and the corresponding actual variable; and,
approximate the friction value based on the determined at least one load characteristic and based on the determined at least one of the manipulated variable deviation and the setpoint-actual deviation.

19. A computer program product comprising:
program code for approximating a friction value between wheels of the vehicle in a current vehicle configuration and a roadway which is stored on a computer-readable data carrier;
said program code being configured to:
determine at least one load characteristic of the current vehicle configuration;
determine a setpoint variable of the vehicle for a driving situation;
determine a manipulated variable expected value, which specifies a predicted value of a manipulated variable to be provided to set the manipulated variable at a steering system, wherein the determination of the manipulated variable expected value is performed using the at least one load characteristic;
determine an actual variable corresponding to the setpoint variable in the driving situation;
determine a manipulated variable actual value, which is provided in the driving situation at the steering system, in order to modulate the actual variable;
determine at least one of a manipulated variable deviation between the manipulated variable expected value and the manipulated variable actual value and a setpoint-actual deviation between the setpoint variable and the corresponding actual variable; and,
approximate the friction value based on the determined at least one load characteristic and based on the determined at least one of the manipulated variable deviation and the setpoint-actual deviation.
